(19) United States
(12) Patent Application Publication
(10) Pub. No.: US 2024/0353247 A1
(43) Pub. Date: Oct. 24, 2024

(54) FLOW RATE MEASUREMENT UNIT, FLOW RATE MEASUREMENT SYSTEM, AND FLOW RATE MEASUREMENT METHOD

(71) Applicant: CKD CORPORATION, Aichi (JP)

(72) Inventor: Shinichi Nitta, Aichi (JP)

(73) Assignee: CKD CORPORATION, Aichi (JP)

(21) Appl. No.: 18/636,672

(22) Filed: Apr. 16, 2024

(30) Foreign Application Priority Data
Apr. 21, 2023 (JP) 2023-070315

(51) Int. Cl. G01F 1/7086

(52) U.S. Cl. CPC G01F 1/7086

(57) ABSTRACT

A flow rate measurement unit includes: an inflow passage; an outflow passage; a screening passage including an inlet and outlet; an injector that injects a substance into the inflow passage; a first detector that irradiates the inlet with the light having the predetermined wavelength, and detects a first intensity; a second detector that irradiates the outlet with the light having the predetermined wavelength, and detects a second intensity; and a first controller that calculates a flow rate of the liquid by dividing a predetermined volume of the screening passage from the inlet to the outlet by a time difference obtained by subtracting a first time from a second time. The first time is taken from when the substance is injected until the first intensity reaches a peak, and the second time is taken from when the substance is injected until the second intensity reaches a peak.

### CROSS-REFERENCE TO RELATED APPLICATION

The present application claims priority to Japanese Patent Application No. 2023-070315 filed on Apr. 21, 2023, the content of which is incorporated herein by reference in its entirely.

### BACKGROUND

### Technical Field

The present disclosure relates to a flow rate measurement unit that measures a flow rate of a liquid.

### Description of Related Art

For example, there is a small flow rate measurement method of obtaining a flow rate from a passing time between two air bubbles detecting sections by installing a small flow rate pump at a path end, installing a sample injector and a screening tube and the air bubble detecting sections at both ends of the screening tube, and performing air bubble injection using the sample injector while feeding a constant flow rate of carrier solution from the pump (see Japanese Patent Laid-Open No. 2003-270018).

Incidentally, according to the flow rate measurement method described in Japanese Patent Laid-Open No. 2003-270018, there is a concern that air turned into air bubbles may be dissolved in the carrier solution depending on the type of the carrier solution. Also, there is a concern that air bubbles may adhere to an inner wall of a path (including the screening tube) and receive a frictional resistance from the inner wall and the flow velocity of the air bubbles may become lower than the flow velocity of the carrier solution. Therefore, there is a concern that accuracy of measuring the flow rate of the liquid may be degraded.

### SUMMARY

One or more embodiments of the present disclosure provide a flow rate measurement unit capable of improving accuracy of measuring a flow rate of a liquid.

According to one or more embodiments, a flow rate measurement unit includes: an inflow passage into which a liquid flows; an outflow passage out of which the liquid flows; a screening passage comprising an inlet section (i.e., inlet), connected to the inflow passage, into which the liquid from the inflow passage flows, and an outlet section (i.e., outlet), connected to the outflow passage, out of which the liquid flows to the outflow passage, the screening passage from the inlet section to the outlet section having a predetermined volume; an injection device that injects, into the inflow passage, a predetermined substance that is soluble in the liquid and exhibits a fluorescence reaction or a light absorption reaction in response to light having a predetermined wavelength; a first detector that irradiates the inlet section with the light having the predetermined wavelength and detects a first intensity that is an intensity of the fluorescence reaction or the light absorption reaction; a second detector that irradiates the outlet section with the light having the predetermined wavelength and detects a second intensity that is an intensity of the fluorescence reaction or the light absorption reaction; and a first controller that calculates a flow rate of the liquid by dividing the predetermined volume by a time difference obtained by subtracting a first time from a second time, the first time being taken from when the injection device injects the predetermined substance until the first intensity detected by the first detector reaches a peak, the second time being taken from when the injection device injects the predetermined substance until the second intensity detected by the second detector reaches a peak.

According to the above configuration, the screening passage includes the inlet section, connected to the inflow passage, into which the liquid from the inflow passage flows, and the outlet section, connected to the outflow passage, out of which the liquid flows to the outflow passage. Therefore, the liquid that has flowed in from the inflow passage flows into the screening passage via the inlet section, is distributed through the screening passage, and then flows out from the outflow passage via the outlet section. The screening passage from the inlet section to the outlet section has the predetermined volume.

The injection device injects, into the inflow passage, the predetermined substance that is soluble in the liquid and exhibits the fluorescence reaction or the light absorption reaction in response to the light having the predetermined wavelength. The first detector irradiates the inlet section with the light having the predetermined wavelength and detects the first intensity that is the intensity of the fluorescence reaction or the light absorption reaction. Therefore, a change indicating presence of the predetermined substance appears in the first intensity detected by the first detector when the predetermined substance passes through the inlet section. Also, the second detector irradiates the outlet section with the light having the predetermined wavelength and detects the second intensity that is the intensity of the fluorescence reaction or the light absorption reaction. Therefore, a change indicating presence of the predetermined substance appears in the second intensity detected by the second detector when the predetermined substance passes through the outlet section.

Here, since the predetermined substance is soluble in the liquid, it is possible to suppress influences of whether or not the predetermined substance is soluble in the liquid on the first intensity and the second intensity unlike a case where air bubbles are occasionally soluble or insoluble. Furthermore, since the predetermined substance is dissolved in the liquid and flows, the predetermined substance is unlikely to adhere to an inner wall of the passage and receive a frictional resistance from the inner wall, and it is possible to prevent a flow velocity of the predetermined substance from becoming lower than a flow velocity of the liquid. Also, the first controller calculates the flow rate of the liquid by dividing the predetermined volume by the time difference obtained by subtracting the first time from the second time, the first time being taken from when the injection device injects the predetermined substance until the first intensity detected by the first detector reaches the peak, the second time being taken from when the injection device injects the predetermined substance until the second intensity detected by the second detector reaches the peak. Therefore, it is possible to suppress influences of the dissolution of the predetermined substance in the liquid and influences of the inner wall of the passage on the predetermined substance and to improve accuracy of measuring the flow rate of the liquid. Furthermore, times until the first intensity and the second intensity reach the peaks are measured as the first time and the second time, respectively. Therefore, there is no need to detect the small first intensity and second intensity, and it is possible to stably measure the first time and the second time.

According to one or more embodiments, the inlet section and the outlet section are arranged side by side in a predetermined direction, the first detector and the second detector constitute a single common detector, and the common detector irradiates the inlet section and the outlet section with the light having the predetermined wavelength in the predetermined direction and detects the first intensity and the second intensity.

According to the above configuration, the inlet section and the outlet section are arranged side by side in the predetermined direction. Therefore, it is possible to configure the first detector and the second detector by the single common detector and to irradiate the inlet section and the outlet section with the light having the predetermined wavelength using the common detector, by performing irradiation with the light having the predetermined wavelength in the predetermined direction. Also, the common detector can detect the first intensity and the second intensity at the inlet section and the outlet section, respectively. Therefore, it is possible to integrate the first detector and the second detector as the single common detector and to simplify the configuration of the flow rate measurement unit.

According to one or more embodiments, the screening passage is formed from a capillary tube made of glass on the assumption of the above embodiments. Therefore, it is possible to easily cause the light having the predetermined wavelength with which one of the inlet section and the outlet section has been irradiated to be transmitted to the other. According to such a configuration, the common detector can realize, at low cost, the configuration in which the inlet section and the outlet section are irradiated with the light having the predetermined wavelength in the predetermined direction and the first intensity and the second intensity are detected.

According to one or more embodiments, the first detector includes a first detection head that emits the light having the predetermined wavelength, the second detector includes a second detection head that emits the light having the predetermined wavelength, and a temperature adjustment device that adjusts temperatures of the injection device, a part of the inflow passage from the injection device to the inlet section, the first detection head, the screening passage, and the second detection head to a predetermined temperature is included. According to such a configuration, it is possible to suppress dispersion and variation of the temperature from the part where the predetermined substance is injected to the part where the detection of the predetermined substance is ended in the flow rate measurement unit. Therefore, it is possible to further improve accuracy of measuring the flow rate of the liquid. Furthermore, since the temperature adjustment device adjusts the temperatures at minimum necessary parts, it is possible to avoid an increase in size and an increase in running cost of the flow rate measurement unit.

According to one or more embodiments, the predetermined substance is a fluorescent substance that absorbs light having a first wavelength and exhibits the fluorescence reaction in which fluorescence having a second wavelength longer than the first wavelength is emitted, the first detector irradiates the inlet section with the light having the first wavelength as the predetermined wavelength and detects an intensity of the fluorescence having the second wavelength as the first intensity, and the second detector irradiates the outlet section with the light having the first wavelength as the predetermined wavelength and detects an intensity of the fluorescence having the second wavelength as the second intensity.

With the above configuration, it is possible to employ a fluorescent substance that exhibits the fluorescence reaction as the predetermined substance and to employ a fluorescence detector that detects the fluorescence having the second wavelength as the first detector and the second detector. Typically, sensitivity of the fluorescence detector detecting the intensity of fluorescence is higher than sensitivity of an absorbance detector detecting absorbance. Therefore, it is possible to further improve accuracy of measuring the flow rate of the liquid.

According to one or more embodiments, a flow rate measurement unit includes: an inflow passage into which a liquid flows; an outflow passage out of which the liquid flows; a screening passage comprising an inlet section (i.e., inlet), connected to the inflow passage, into which the liquid from the inflow passage flows, and an outlet section (i.e., outlet), connected to the outflow passage, out of which the liquid flows to the outflow passage, the screening passage from the inlet section to the outlet section having a predetermined volume; an injection device that injects, into the inflow passage, a predetermined substance that is soluble in the liquid and exhibits a fluorescence reaction or a light absorption reaction in response to light having a predetermined wavelength; a first detector that irradiates the inlet section with the light having the predetermined wavelength and detects a first intensity that is an intensity of the fluorescence reaction or the light absorption reaction; a second detector that irradiates the outlet section with the light having the predetermined wavelength and detects a second intensity that is an intensity of the fluorescence reaction or the light absorption reaction; and a first controller that calculates a flow rate of the liquid by dividing the predetermined volume by a time difference obtained by subtracting a first time from a second time, the first time being taken from when the injection device injects the predetermined substance until the first intensity detected by the first detector exceeds a first threshold value, the second time being taken from when the injection device injects the predetermined substance until the second intensity detected by the second detector exceeds a second threshold value.

According to the above configuration, the first intensity detected by the first detector increases when the predetermined substance passes through the inlet section. Also, the second intensity detected by the second detector increases when the predetermined substance passes through the outlet section. Moreover, the first controller calculates the flow rate of the liquid by dividing the predetermined volume by the time difference obtained by subtracting the first time from the second time, the first time being taken from when the injection device injects the predetermined substance until the first intensity detected by the first detector exceeds the first threshold value, the second time being taken from when the injection device injects the predetermined substance until the second intensity detected by the second detector exceeds the second threshold value. Note that the second threshold value may be the same as the first threshold value or may be a smaller value than the first threshold value.

Here, since the predetermined substance is soluble in the liquid, it is possible to suppress influences of whether or not the predetermined substance is dissolved in the liquid on the first intensity and the second intensity unlike a case where air bubbles are occasionally soluble or insoluble. Furthermore, since the predetermined substance is dissolved in the liquid and flows, the predetermined substance is unlikely to adhere to the inner wall of the passage and receive a frictional resistance from the inner wall, and it is possible to prevent the flow velocity of the predetermined substance from becoming lower than the flow velocity of the liquid. Therefore, it is possible to suppress influences of the dissolution of the predetermined substance in the liquid and influences of the inner wall of the passage on the predetermined substance and to improve accuracy of measuring the flow rate of the liquid with the above configuration as well.

According to one or more embodiments, a flow rate measurement system includes: the flow rate measurement unit according to the above embodiments; a liquid feeding unit including a pump that pumps the liquid, a flow rate sensor that outputs an output signal with a correlation with a flow rate of the liquid pumped from the pump to the inflow passage, and a second controller that controls the pump such that the output signal from the flow rate sensor becomes a target output signal.

With the above configuration, the pump pumps the liquid, and the flow rate sensor outputs the output signal with the correlation with the flow rate of the liquid pumped from the pump to the inflow passage. Then, the second controller controls the pump such that the output signal from the flow rate sensor becomes the target output signals. Therefore, it is possible to calculate the flow rate of the liquid by the flow rate measurement unit in a state where the output signal from the flow rate sensor has become the target output signal. In other words, it is possible to change the flow rate of the liquid by the second controller when the flow rate of the liquid is measured by the flow rate measurement unit.

According to one or more embodiments, the liquid feeding unit includes a storage device that stores information, the second controller controls the pump such that the output signals from the flow rate sensor successively becomes a plurality of target output signals, the first controller calculates the flow rate of the liquid in a state where the output signals from the flow rate sensor respectively become the target output signals, and the second controller causes the storage device to store each of the target output signals and the flow rate of the liquid calculated by the first controller to be associated with each other.

According to the above configuration, the second controller controls the pump such that the output signals from the flow rate sensor successively become the target output signals. At this time, the first controller calculates the flow rate of the liquid in the state where the output signals from the flow rate sensor respectively become the target output signals. Therefore, it is possible to accurately calculate the flow rate of the liquid in the state where the pump is controlled such that the output signals from the flow rate sensor respectively become the target output signals. In other words, it is possible to calculate the accurate flow rate of the liquid corresponding to each of the target output signals. Also, the second controller causes the storage device to store each of the target output signals and the flow rate of the liquid calculated by the first controller to be associated with each other. Therefore, it is possible to obtain (correct) a relationship between the target output signals and accurate flow rates of the liquid corresponding thereto and to cause the storage device to store the relationship. Therefore, it is possible to highly accurately and simply perform the correction of the liquid feeding unit.

According to one or more embodiments, a flow rate measurement method is for measuring a flow rate of a liquid. The method includes preparing a flow rate measurement unit comprising: an inflow passage into which the liquid flows, an outflow passage out of which the liquid flows, a screening passage comprising an inlet section (i.e., inlet), connected to the inflow passage, into which the liquid from the inflow passage flows, and an outlet section (i.e., outlet), connected to the outflow passage, out of which the liquid flows to the outflow passage, the screening passage from the inlet section to the outlet section having a predetermined volume, an injection device that injects, into the inflow passage, a predetermined substance that is soluble in the liquid and exhibits a fluorescence reaction or a light absorption reaction in response to light having a predetermined wavelength, a first detector that irradiates the inlet section with the light having the predetermined wavelength and detects a first intensity that is an intensity of the fluorescence reaction or the light absorption reaction, and a second detector that irradiates the outlet section with the light having the predetermined wavelength and detects a second intensity that is an intensity of the fluorescence reaction or the light absorption reaction. The method further includes calculating a flow rate of the liquid by dividing the predetermined volume by a time difference obtained by subtracting a first time from a second time, the first time being taken from when the injection device injects the predetermined substance until the first intensity detected by the first detector reaches a peak, the second time being taken from when the injection device injects the predetermined substance until the second intensity detected by the second detector reaches a peak.

According to the above process, effects similar to those of the above embodiments can be achieved.

According to one or more embodiments, the inlet section and the outlet section are arranged side by side in a predetermined direction, the first detector and the second detector constitute a single common detector, and the common detector irradiates the inlet section and the outlet section with the light having the predetermined wavelength in the predetermined direction and detects the first intensity and the second intensity.

According to the above process, effects similar to those of the above embodiments can be achieved.

According to one or more embodiments, a flow rate measurement method is for measuring a flow rate of a liquid. The method includes preparing a flow rate measurement unit comprising: an inflow passage into which the liquid flows; an outflow passage out of which the liquid flows; a screening passage comprising an inlet section (i.e., inlet), connected to the inflow passage, into which the liquid from the inflow passage flows, and an outlet section (i.e., outlet), connected to the outflow passage, out of which the liquid flows to the outflow passage, the screening passage from the inlet section to the outlet section having a predetermined volume; an injection device (i.e., injector) that injects, into the inflow passage, a predetermined substance that is soluble in the liquid and exhibits a fluorescence reaction or a light absorption reaction in response to light having a predetermined wavelength; a first detector that irradiates the inlet section with the light having the predetermined wavelength and detects a first intensity that is an intensity of the fluorescence reaction or the light absorption reaction; and a second detector that irradiates the outlet section with the light having the predetermined wavelength and detects a second intensity that is an intensity of the fluorescence reaction or the light absorption reaction. The method further includes calculating a flow rate of the liquid by dividing the predetermined volume by a time difference obtained by subtracting a first time from a second time, the first time being taken from when the injection device injects the predetermined substance until the first intensity detected by the first detector exceeds a first threshold value, the second time being taken from when the injection device injects the predetermined substance until the second intensity detected by the second detector exceeds a second threshold value.

According to the above process, effects similar to those of the above embodiments can be achieved.

According to one or more embodiments, the flow rate measurement unit further includes a pump that pumps the liquid; a flow rate sensor that outputs an output signal with a correlation with a flow rate of the liquid pumped from the pump to the inflow passage; and a storage device that stores information. The method further includes: controlling the pump such that output signals from the flow rate sensor successively become a plurality of target output signals; calculating the flow rate of the liquid in a state where the output signals from the flow rate sensor respectively become the target output signals; and causing the storage device to store each of the target output signals and the calculated flow rate of the liquid to be associated with each other.

According to the above process, effects that are similar to those of the above embodiments can be achieved.

### BRIEF DESCRIPTION OF THE DRAWINGS

The aforementioned features and advantages of the present disclosure will be further clarified by the following detailed description with reference to the accompanying drawings.

FIG. 1 is a schematic view illustrating a liquid feeding unit and a flow rate measurement unit according to a first embodiment;

FIG. 2 is a time chart illustrating a waveform and a peak time difference illustrating a relationship between a time and fluorescence intensity;

FIG. 3 is a table illustrating results of calculating a first time t11, a second time t12, and a time difference Δt1;

FIG. 4 is a schematic view illustrating a modification of the flow rate measurement unit;

FIG. 5 is a schematic view illustrating another modification of the flow rate measurement unit;

FIG. 6 is a block diagram of the liquid feeding unit;

FIG. 7 is a schematic view illustrating a flow rate measurement system according to a second embodiment;

FIG. 8 is a flowchart illustrating a procedure of a flow rate measurement method;

FIG. 9 is a table illustrating a relationship between a sensor voltage and a measured flow rate;

FIG. 10 is a graph illustrating the relationship between the sensor voltage and the flow rate;

FIG. 11 is a schematic view illustrating a modification of the flow rate measurement system;

FIG. 12 is a time chart illustrating a modification of a waveform and a peak time difference illustrating a relationship between a time and a fluorescence intensity;

FIG. 13 is a schematic view illustrating a liquid feeding unit and a flow rate measurement unit according to a third embodiment;

FIG. 14 is a time chart illustrating a waveform and a peak time difference illustrating a relationship between a time and an absorbance; and

FIG. 15 is a time chart illustrating a modification of a waveform and a peak time difference illustrating a relationship between a time and an absorbance.

### DETAILED DESCRIPTION OF EMBODIMENTS

### First Embodiment

Hereinafter, a first embodiment that is implemented as a flow rate measurement unit that measures a flow rate of a liquid fed by a liquid feeding unit will be described with reference to the drawings. The liquid feeding unit is used in a liquid chromatography for a small flow rate (less than 1000 [nL/min], for example) and feeds a small flow rate of liquid.

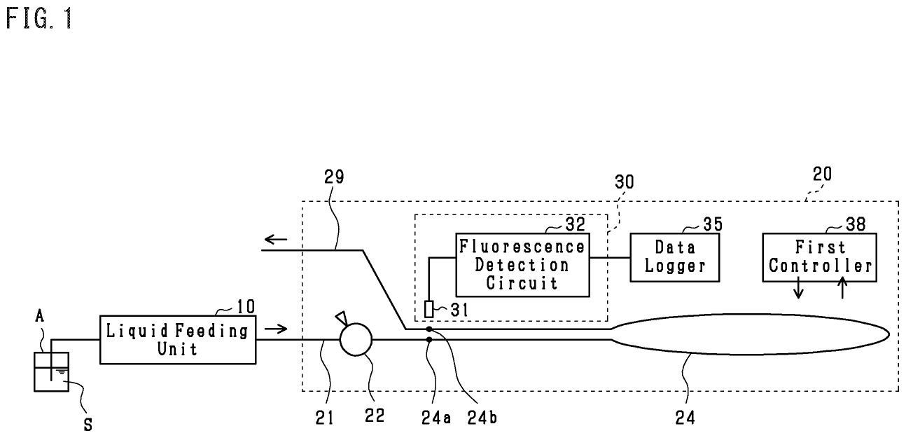

As illustrated in FIG. 1, a liquid feeding unit 10 suctions a solvent S from a solvent container A and ejects the solvent S to a flow rate measurement unit 20. The solvent S (liquid) is, for example, pure water, acetonitrile, a mixture solution thereof, or the like.

The flow rate measurement unit 20 includes an inflow passage 21, an injector 22, a screening tube 24, a fluorescence detector 30, a data logger 35, a first controller 38, an outflow passage 29, and the like.

The inflow passage 21 is connected to the liquid feeding unit 10, and the solvent S flows into the inflow passage 21. The inflow passage 21 is provided with the injector 22. The injector 22 (injection device) injects a fluorescent sample F into the inflow passage 21. The fluorescent sample F is soluble in the solvent S and exhibits a fluorescence reaction in response to light having a predetermined wavelength. The fluorescent sample F is a solution of a fluorescent substance that absorbs light having a first wavelength and emits fluorescence having a second wavelength longer than the first wavelength. The first wavelength corresponds to ultraviolet light or visible light, for example. For example, the fluorescent substance (predetermined substance) is a coumarin derivative (7-diethylamino-4-methylcoumarin). The coumarin derivative has a characteristic that the coumarin derivative is easily dissolved in both a water-based solvent and an organic solvent. The injector 22 is controlled by the first controller 38.

The screening tube 24 (screening passage) is formed from a capillary tube made of glass. The inner diameter of the screening tube 24 is, for example, 20 to 200 [μm], and the length of the screening tube 24 is, for example, 200 to 2000 [mm]. The screening tube 24 allows light having the aforementioned first wavelength and fluorescence having the aforementioned second wavelength to be transmitted therethrough. The screening tube 24 is formed into a shape in which the screening tube 24 extends in one direction and is then folded back in an opposite direction, for example, into a “C” shape or a “U” shape. The screening tube 24 includes an inlet section (or inlet) 24a and an outlet section (or outlet) 24b. The inlet section 24a is connected to the inflow passage 21, and the solvent S flows in from the inflow passage 21. The outlet section 24b is connected to the outflow passage 29, and the solvent S flows out to the outflow passage 29. The outflow passage 29 causes the solvent S to flow out to the outside of the flow rate measurement unit 20. The inlet section 24a and the outlet section 24b are arranged side by side in a predetermined direction (the up-down direction in FIG. 1) and face each other.

The screening tube 24 from the inlet section 24a to the outlet section 24b has a predetermined volume V. The predetermined volume V can be measured in advance based on the weight of the liquid calculated by a highly precise electronic balance in an environment highly precisely (strictly) managed. At this time, it is possible to accurately measure the predetermined volume V by measuring the predetermined volume V with the flow rate with which measurement is easily performed, by using a liquid (pure water, for example) with which measurement is easily performed.

The fluorescence detector 30 (common detector) includes a detection head 31, a fluorescence detection circuit 32, and the like.

The detection head 31 (a first detection head, a second detection head) projects or emits light (irradiation) with the aforementioned first wavelength dispersed from light from a light source and receives fluorescence having the aforementioned second wavelength emitted from the fluorescent sample F. The detection head 31 is disposed on the side opposite to the inlet section 24a with respect to the outlet section 24b and faces the outlet section 24b. In other words, the outlet section 24b is disposed between the detection head 31 and the inlet section 24a. Therefore, the outlet section 24b is irradiated with the light having the first wavelength in the aforementioned predetermined direction by the detection head 31 as the second detection head, and it is thus possible to irradiate the inlet section 24a with the light having the first wavelength, which has been transmitted through the outlet section 24b, as the first detection head. Then, the detection head 31 serves as the first detection head to receive the fluorescence having the second wavelength emitted from the fluorescent sample F and passing through the inlet section 24a, and serves as the second detection head to receive the fluorescence having the second wavelength emitted from the fluorescent sample F and passing through the outlet section 24b.

The fluorescence detection circuit 32 detects an intensity of the fluorescence having the second wavelength received by the detection head 31. The fluorescence detection circuit 32 includes, for example, a spectrometer, a photomultiplier tube, an A/D conversion circuit, and the like.

The fluorescence detector 30 irradiates the inlet section 24a and the outlet section 24b with the light having the first wavelength in the predetermined direction and detects a first intensity that is an intensity of the fluorescence having the second wavelength from the inlet section 24a and a second intensity that is an intensity of the fluorescence having the second wavelength from the outlet section 24b. Therefore, the fluorescence detector 30 has a function as a first detector of irradiating the inlet section 24a with the light having the first wavelength and detecting the first intensity that is the intensity of the fluorescence reaction and a function as a second detector of irradiating the outlet section 24b with the light having the first wavelength and detecting the second intensity that is the intensity of the fluorescence reaction.

The data logger 35 sequentially saves data regarding the intensities of the fluorescence having the second wavelength detected by the fluorescence detection circuit 32.

The first controller 38 is configured as a computer including, for example, a CPU, a ROM, a RAM, an input/output interface, and the like. The first controller 38 can control the injector 22 and read data saved by the data logger 35. The first controller 38 calculates the flow rate of the solvent S based on the data read from the data logger 35 and the aforementioned predetermined volume V.

The flow rate measurement unit 20 with the aforementioned configuration calculates the flow rate of the solvent S as follows. In other words, it is possible to perform the following flow rate measurement method by using the flow rate measurement unit 20.

The liquid feeding unit 10 suctions the solvent S from the solvent container A and ejects the solvent S to the flow rate measurement unit 20 in a state where the flow rate of the solvent S to be measured is stabilized at a constant flow rate. The first controller 38 controls the injector 22, causes the injector 22 to inject the fluorescent sample F into the flow-in passage 21, and at the same time, starts time measurement and data reading from the data logger 35. At this time, the fluorescent substance contained in the fluorescent sample F is dissolved in the solvent S. In other words, unlike air bubbles, the fluorescent substance does not change, as what is occasionally soluble or insoluble in the solvent S, and the fluorescent substance is always dissolved in the solvent S. Also, unlike air bubbles, the fluorescent substance is dissolved in the solvent S and is unlikely to adhere to an inner wall of a passage. This prevents a flow velocity of the fluorescent substance from becoming lower than a flow velocity of the solvent S. Note that the fluorescence detector 30 may start detection of fluorescence before the fluorescent sample F is injected into the inflow passage 21 or may start the detection of the fluorescence at the same time with the injection of the fluorescent sample F into the inflow passage 21.

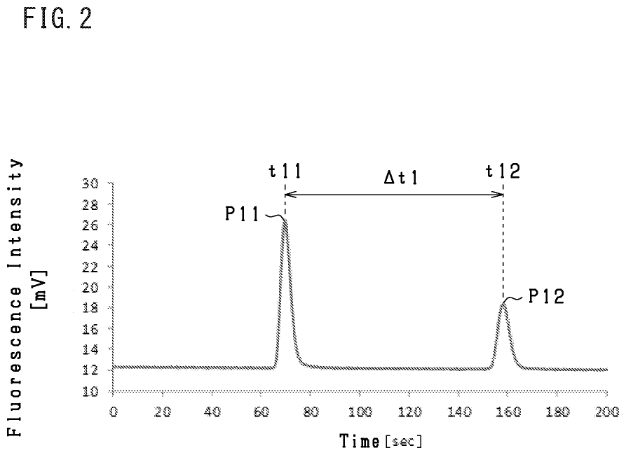

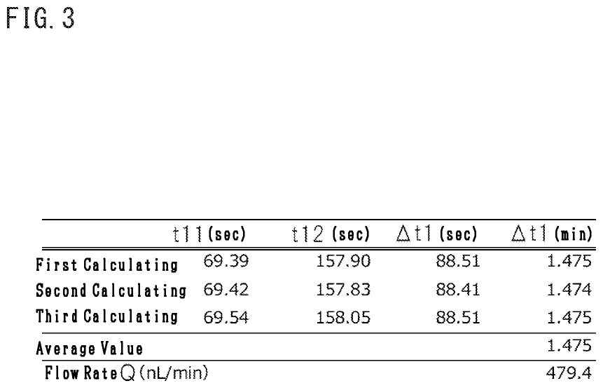

The first controller 38 creates (acquires) a waveform indicating a relationship between a time taken after the fluorescent sample F is injected by the injector 22 and a detected fluorescence intensity as illustrated in FIG. 2 based on the data read from the data logger 35. Based on the waveform, the first controller 38 calculates a first time t11 taken from when the fluorescent sample F is injected until the waveform reaches a first peak P11 and a second time t12 taken from when the fluorescent sample F is injected until the waveform reaches a second peak P12. The first controller 38 calculates a time difference Δt1 by subtracting the first time t11 from the second time t12. FIG. 3 is a table illustrating a result of calculating the first time t11, the second time t12, and the time difference Δt1 three times. Here, the inner diameter of the screening tube 24 is 30 [μm], and the length of the screening tube 24 is 1000 [mm]. Then, the first controller 38 calculates a flow rate Q by dividing the aforementioned predetermined volume V by an average value of the time difference Δt1.

The present embodiment described above in detail has the following advantages.
Since the fluorescent substance is soluble in the solvent S, it is possible to suppress influences of whether or not the fluorescent substance is dissolved in the solvent S on the first intensity and the second intensity unlike a case where air bubbles are occasionally soluble or insoluble in the solvent S. Furthermore, since the fluorescent substance is dissolved in the solvent S and flows, the fluorescent substance is unlikely to adhere to the inner wall of the passage and receive a frictional resistance from the inner wall, and it is possible to prevent the flow velocity of the fluorescent substance from becoming lower than the flow velocity of the solvent S. Then, the first controller 38 calculates the flow rate Q of the solvent S by dividing the predetermined volume V by the time difference Δt1 obtained by subtracting the first time t11, which is taken from when the fluorescent substance is injected by the injector 22 until the first intensity detected by the fluorescence detector 30 as the first detector reaches the first peak P11, from the second time t12, which is taken from when the fluorescent substance is injected by the injector 22 until the second intensity detected by the fluorescence detector 30 as the second detector reaches the second peak P12. Therefore, it is possible to suppress influences of dissolution of the fluorescent substance in the solvent S and influences of the inner wall of the passage on the fluorescent substance and to improve accuracy of measuring the flow rate Q of the solvent S.
As the first time t11 and the second time t12, times taken until the first intensity and the second intensity reach the peaks P11 and P12 are measured, respectively. Therefore, there is no need to detect the small first intensity and second intensity, and it is possible to stably measure the first time t11 and the second time t12.
The inlet section 24a and the outlet section 24b are arranged side by side in the predetermined direction. Therefore, it is possible to configure the first detector and the second detector by the single fluorescence detector 30 and to irradiate the inlet section 24a and the outlet section 24b with the light having the first wavelength by the fluorescence detector 30, by performing irradiation with the light having the first wavelength in the predetermined direction. Then, the fluorescence detector 30 can detect the first intensity and the second intensity at the inlet section 24a and the outlet section 24b, respectively. Therefore, it is possible to integrate the first detector and the second detector as the single fluorescence detector 30 and to simplify the configuration of the flow rate measurement unit 20.
Since the screening tube 24 is formed from the capillary tube made of glass, it is possible to easily cause the light having the first wavelength, with which one of the inlet section 24a and the outlet section 24b has been irradiated, to be transmitted to the other. According to such a configuration, the fluorescence detector 30 can realize, at low cost, the configuration of irradiating the inlet section 24a and the outlet section 24b with the light having the first wavelength in the predetermined direction and detecting the first intensity and the second intensity.
Typically, sensitivity of a fluorescence detector detecting an intensity of fluorescence is higher than sensitivity of an absorbance detector detecting absorbance. Therefore, it is possible to improve accuracy of measuring the flow rate Q of the solvent S as compared with a configuration in which UV absorbance (absorbance) is detected by a UV detector (absorbance detector) using a UV absorbing substance (light absorbing substance) that exhibits a UV absorption reaction (light absorption reaction) as a predetermined substance.

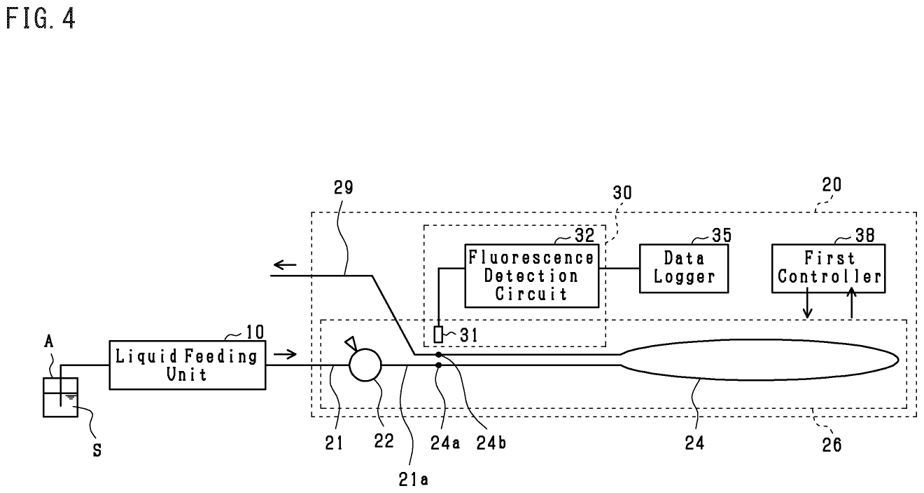

Note that the first embodiment can be modified and performed as follows. The same parts as those in the first embodiment will be denoted by the same reference signs, and description will be omitted.
As illustrated in FIG. 4, the flow rate measurement unit 20 may include a temperature adjustment device 26. The temperature adjustment device 26 includes, for example, a case that accommodates a target of temperature adjustment, a heater, a chiller, a blower, and the like. The temperature adjustment device 26 adjusts temperatures of the injector 22, a part 21a of the inflow passage 21 from the injector 22 to the inlet section 24a, the detection head 31 (the first detection head and the second detection head) of the fluorescence detector 30, and the screening tube 24 to a predetermined temperature T. The predetermined temperature T is a standard temperature (25 [° C.], for example) that is standard as a utilization temperature at which the liquid feeding unit 10 is used in a liquid chromatography for a small flow rate or a test temperature, for example. The temperature adjustment device 26 is controlled by the first controller 38.

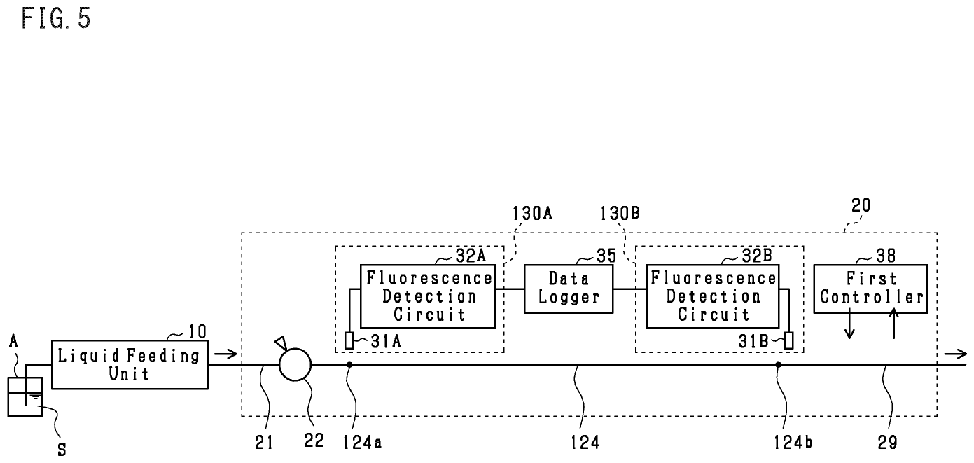

According to the aforementioned configuration, it is possible to suppress dispersion and variation of the temperature from the part (injector 22) where the fluorescent substance is injected to the part (detection head 31) where the detection of the fluorescent substance is ended in the flow rate measurement unit 20. Therefore, it is possible to further improve accuracy of measuring the flow rate of the solvent S. Furthermore, since the temperature adjustment device 26 adjusts the temperature at a minimum necessary part, it is possible to avoid an increase in size and an increase in running cost of the flow rate measurement unit 20. Note that it is also possible to adjust the temperature of the entire flow rate measurement unit 20 to the predetermined temperature T by the temperature adjustment device 26.
As illustrated in FIG. 5, the flow rate measurement unit 20 may include a screening tube 124 that is formed into a shape in which the screening tube 124 just extends in one direction and is not folded back, a first detector 130A, and a second detector 130B. The screening tube 124 (screening passage) is formed from a capillary tube made of glass. The inner diameter of the screening tube 124 is, for example, 20 to 200 [μm], and the length of the screening tube 124 is, for example, 200 to 2000 [mm]. The screening tube 124 causes light having the aforementioned first wavelength and fluorescence having the second wavelength to be transmitted therethrough. The screening tube 124 is formed into a linear shape. The screening tube 124 includes an inlet section (or inlet) 124a and an outlet section (or outlet) 124b. The inlet section 124a is connected to the inflow passage 21, and the solvent S flows in from the inflow passage 21. The outlet section 124b is connected to the outflow passage 29, and the solvent S flows out to the outflow passage 29. The screening tube 124 from the inlet section 124a to the outlet section 124b has a predetermined volume V. Note that it is also possible to form the screening tube 124 into a curved shape in which the screening tube 124 is not folded back.

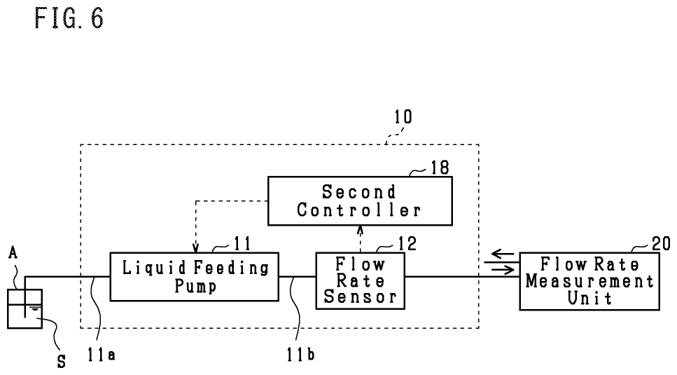

The first detector 130A includes a configuration that is similar to that of the aforementioned fluorescence detector 30 and includes a first detection head 31A that is similar to the aforementioned detection head 31 and a first fluorescence detection circuit 32A that is similar to the aforementioned fluorescence detection circuit 32. The first detection head 31A faces the inlet section 124a. The second detector 130B includes a configuration that is similar to that of the aforementioned fluorescence detector 30 and includes a second detection head 31B that is similar to the aforementioned detection head 31 and a second fluorescence detection circuit 32B that is similar to the aforementioned fluorescence detection circuit 32. The second detection head 31B faces the outlet section 124b. In other words, the functions of the fluorescence detector 30 are realized by the first detector 130A and the second detector 130B. It is possible to achieve effects that are similar to those of the first embodiment other than that it is possible to integrate the first detector 130A and the second detector 130B as a single fluorescence detector 30, with the aforementioned configuration as well.
As illustrated in FIG. 6, the liquid feeding unit 10 includes, for example, a liquid feeding pump 11, a flow rate sensor 12, and a second controller 18. The liquid feeding pump 11 (pump) suctions the solvent S from a suctioning passage 11a and pumps the solvent S to the ejection passage 11b. The ejection passage 11b is provided with the flow rate sensor 12. The flow rate sensor 12 is, for example, a thermal flow rate sensor. The flow rate sensor 12 outputs an output signal with a correlation with the flow rate of the solvent S flowing through the ejection passage 11b, that is, the solvent S pumped from the liquid feeding pump 11 to the aforementioned inflow passage 21. The output signal is output as a sensor voltage [V], for example. The second controller 18 is configured as a computer including, for example, a CPU, a ROM, a RAM, an input/output interface, and the like. The second controller 18 performs feedback control on the liquid feeding pump 11 such that the output signal from the flow rate sensor 12 becomes a target output signal. According to the aforementioned configuration, it is possible to calculate the flow rate Q of the solvent S by the flow rate measurement unit 20 in a state where the output signal from the flow rate sensor 12 has become the target output signal. In other words, it is possible to change the flow rate of the solvent S by the second controller 18 when the flow rate Q of the solvent S is measured by the flow rate measurement unit 20.

### Second Embodiment

Hereinafter, a second embodiment that is realized as a flow rate measurement system including a flow rate measurement unit and a liquid feeding unit will be described with reference to drawings. The same parts as those in the first embodiment and the modification thereof will be denoted by the same reference signs, and description will be omitted.

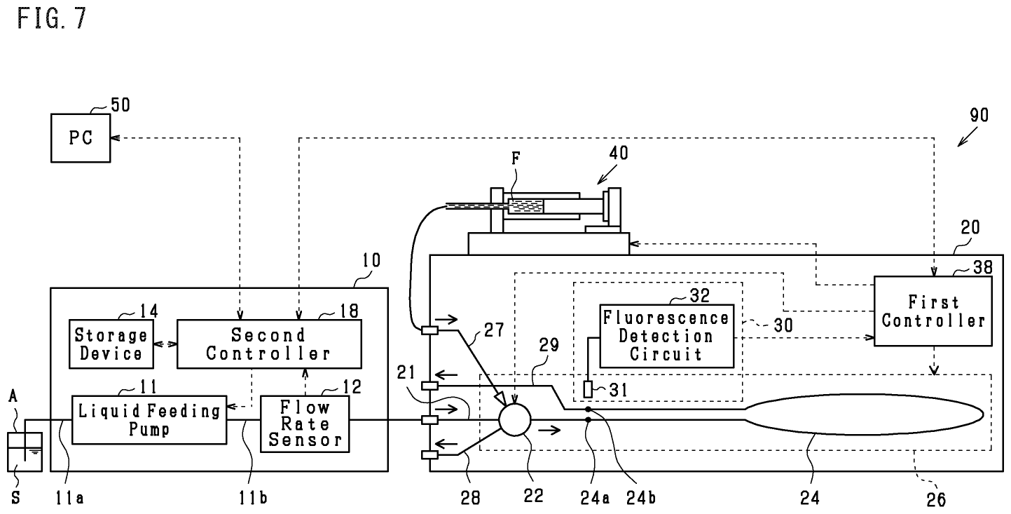

As illustrated in FIG. 7, a flow rate measurement system 90 includes a liquid feeding unit 10, a flow rate measurement unit 20, a syringe pump 40, and the like.

The liquid feeding unit 10 according to the present embodiment includes a storage device 14 that stores information (data). The storage device 14 is a programmable ROM (PROM) that allows a user to perform deletion and writing, for example. A second controller 18 writes information in the storage device 14 and reads information from the storage device 14.

The syringe pump 40 is connected to an injector 22. The syringe pump 40 injects a set constant amount of fluorescent sample F into the injector 22 through a sample supply passage 27. The syringe pump 40 is controlled by a first controller 38. Note that it is possible to discharge a fluorescent sample F from the injector 22 through a sample discharge passage 28.

A PC 50 is connected to the second controller 18. The PC 50 is configured as a computer including, for example, a CPU, a ROM, a RAM, an input/output interface, a keyboard, a mouse, and the like. The PC 50 and the second controller 18 transmit and receive information to and from each other. The first controller 38 is connected to the second controller 18. The second controller 18 and the first controller 38 transmit and receive information to and from each other. The PC 50 and the first controller 38 transmit and receive information to and from each other via the second controller 18.

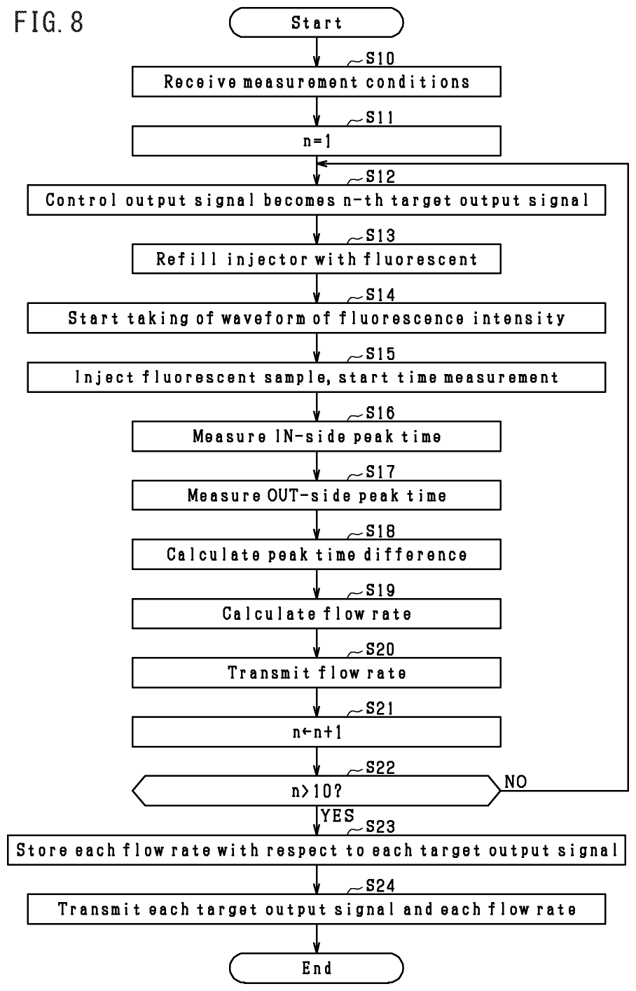

FIG. 8 is a flowchart illustrating a procedure of a flow rate measurement method performed by the first controller 38 and the second controller 18.

First, the second controller 18 receives measurement conditions from the PC 50 and transmits the measurement conditions to the first controller 38 (S10). The measurement conditions include, for example, the target output signals that are targets to which the output signal of the flow rate sensor 12 is to be controlled when a flow rate Q of the solvent S is measured, a predetermined volume V of the screening tube 24, a predetermined temperature T to which adjustment is performed by a temperature adjustment device 26, and the like.

Next, the second controller 18 sets n=1 (S11) and controls the liquid feeding pump 11 such that the output signal from the flow rate sensor 12 becomes an n-th target output signal (S12).

Next, the first controller 38 causes the syringe pump 40 to refill the injector 22 with the fluorescent sample F (S13). The first controller 38 starts taking of a waveform of a fluorescence intensity from the fluorescence detector 30 (S14), causes the injector 22 to inject the fluorescent sample F into the inflow passage 21, and starts time measurement (S15).

Next, the first controller 38 measures, as an IN-side peak time, a first time t11 taken from when the fluorescent sample F is injected until the waveform reaches a first peak P11 (S16). In other words, the time taken from when the fluorescent sample F is injected until the waveform reaches a peak for the first time is measured as the first time t11. The first controller 38 measures, as an OUT-side peak time, a second time t12 taken from when the fluorescent sample F is injected until the waveform reaches a second peak P12 (S17). In other words, the time taken from when the fluorescent sample F is injected until the waveform reaches the peak for the second time is measured as the second time t12.

Then, the first controller 38 calculates a time difference between the OUT-side peak time and the IN-side peak time (S18). Specifically, a time difference Δt1 obtained by subtracting the first time t11 from the second time t12 is calculated. The first controller 38 calculates the flow rate Q by dividing the predetermined volume V by the time difference Δt1 (S19) and transmits the flow rate Q to the second controller 18 (S20).

Then, the second controller 18 sets a value obtained by adding 1 to n as new n (S21) and determines whether or not n is greater than 10 (S21). In a case where it is determined that n is not greater than 10 in the determination (S22: NO), the processing from S12 is executed again. In other words, the first controller 38 calculates the flow rate Q of the solvent S in a state where output signals from the flow rate sensor 12 respectively become the target output signals.

On the other hand, in a case where it is determined that n is greater than 10 in the determination in S22 (S22: YES), the second controller 18 causes the storage device 14 to store each flow rate Q with respect to each target output signal (S23). In other words, the storage device 14 is caused to store each target output signal and each calculated flow rate Q to be associated with each other. The second controller 18 associates and transmits each target output signal and each flow rate Q to the PC 50 (S24). Thereafter, the series of processing is ended (END).

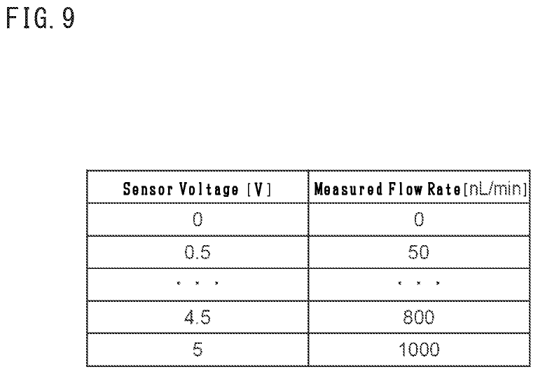

FIG. 9 is a table illustrating a relationship between a sensor voltage [V] acquired by performing the flow rate measurement method in FIG. 8 and a measured flow rate [nL/min]. The sensor voltage is a voltage (output signal) that corresponds to (is correlated with) the flow rate of the solvent S and is output from the flow rate sensor 12. The measured flow rate is each flow rate Q calculated in a state where the sensor voltage is each value. It is thus possible to acquire an accurate relationship between the sensor voltage and the flow rate of the solvent S and to correct the liquid feeding unit 10. Also, it is possible to accurately control the flow rate of the solvent S to 50 [nL/min] by the second controller controlling the liquid feeding pump 11 such that the sensor voltage output from the flow rate sensor 12 becomes 0.5 [V], for example, using this relationship.

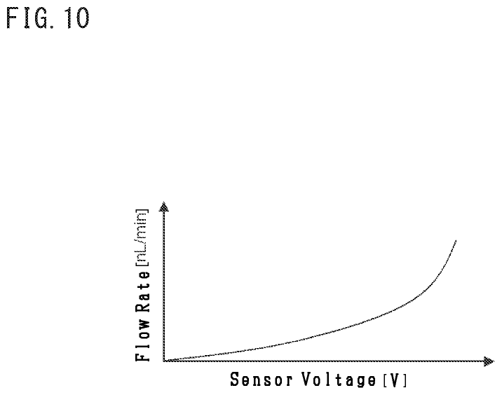

FIG. 10 is a graph illustrating a relationship between a sensor voltage and a flow rate. The PC 50 creates the graph illustrated in FIG. 10 based on each target output signal (sensor voltage) and each flow rate Q received from the second controller 18. For example, the PC 50 calculates an approximate curve that passes a plurality of measurement points defined by the sensor voltage and the flow rate Q. Also, the PC 50 can accurately control the flow rate of the solvent S to the target flow rate by outputting the sensor voltage corresponding to the target flow rate as a target output signal to the second controller 18 using the approximate curve. Note that the PC 50 can also calculate the sensor voltage corresponding to the target flow rate by interpolating parts between the measurement points defined by the sensor voltage and the flow rate Q with straight lines.

According to the present embodiment described above in detail, the second controller 18 controls the liquid feeding pump 11 such that the output signals from the flow rate sensor 12 successively become the target output signals. At this time, the first controller 38 calculates the flow rate Q of the solvent S in a state where the output signals from the flow rate sensor 12 respectively become the target output signals. Therefore, it is possible to accurately calculate the flow rate Q of the solvent S in a state where the liquid feeding pump 11 is controlled such that the output signals from the flow rate sensor 12 respectively become the target output signals. In other words, it is possible to calculate the accurate flow rate Q of the solvent S corresponding to each of the target output signals (output signals detected at that time). Then, the second controller 18 causes the storage device 14 to store each of the target output signals (the output signals detected at that time) and the flow rate Q of the solvent S calculated by the first controller 48 to be associated with each other. Therefore, it is possible to obtain (correct) the relationship between the target output signals and the accurate flow rate Q of the solvent S corresponding thereto and to cause the storage device 14 to store the relationship. Therefore, it is possible to highly accurately and easily correct the liquid feeding unit 10.

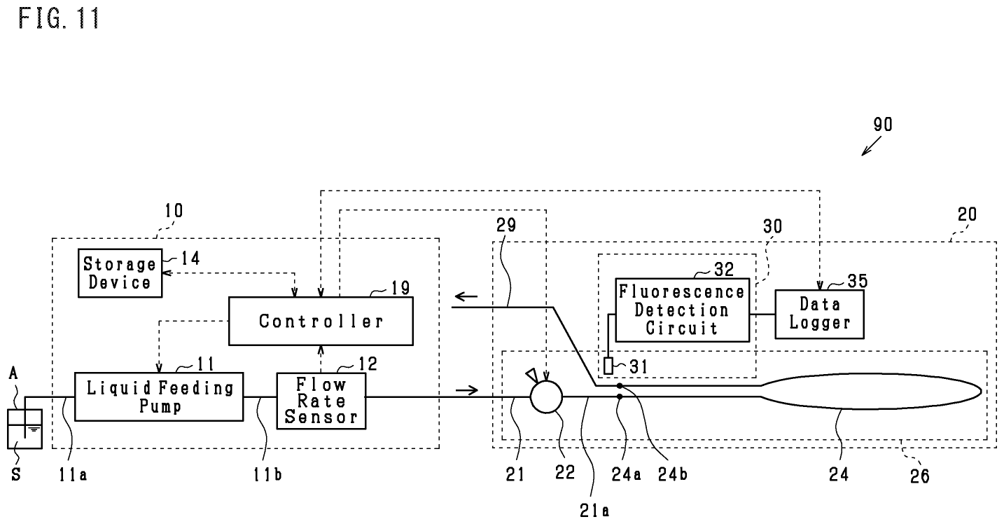

Note that the liquid feeding unit 10 may include a controller 19 that has the functions of the aforementioned first controller 38 and the second controller 18 as illustrated in FIG. 11. It is possible to achieve effects that are similar to those of the second embodiment with such a configuration as well. Additionally, the flow rate measurement unit 20 may include a controller having the functions of the aforementioned first controller 38 and the second controller 18. It is possible to achieve effects that are similar to those of the second embodiment with such a configuration as well.

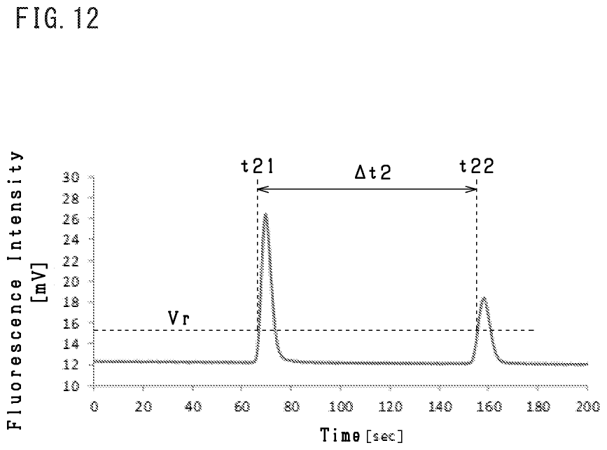

Note that the first embodiment, the modification thereof, and the second embodiment can also be modified and performed as follows. The same parts as those in the first embodiment, the modification thereof, and the second embodiment will be denoted by the same reference signs, and description will be omitted.
As illustrated in FIG. 12, the first controller 38 creates (acquires) a waveform illustrating a relationship between a time after the fluorescent sample F is injected by the injector 22 and a detected fluorescence intensity. Based on the waveform, the first controller 38 calculates a first time t21 taken from when the fluorescent sample F is injected until the waveform exceeds a threshold value Vr (first threshold value) for the first time from a state where the waveform is below the threshold value Vr and a second time t22 taken from when the fluorescent sample F is injected until the waveform exceeds the threshold value Vr (second threshold value) for the second time from the state where the waveform is below the threshold value Vr. The first controller 38 calculates a time difference Δt2 by subtracting the first time t21 from the second time t22. Then, the first controller 38 calculates the flow rate Q by dividing the aforementioned predetermined volume V by the time difference Δt2. It is possible to suppress influences of dissolution of the fluorescent substance in the solvent S and influences of the inner wall of the passage on the fluorescent substance and to improve accuracy of measuring the flow rate of the solvent S with the aforementioned configuration as well. Note that the second threshold value for calculating the second time t22 may be set to be smaller than the first threshold value for calculating the first time t21.
The first controller 38 may be formed from a PC or the like provided outside the flow rate measurement unit 20.

### Third Embodiment

Hereinafter, a third embodiment will be described by focusing on differences from the flow rate measurement unit 20 in FIG. 5. The same parts as those in the first embodiment and the flow rate measurement unit 20 in FIG. 5 will be denoted by the same reference signs, and description will be omitted.

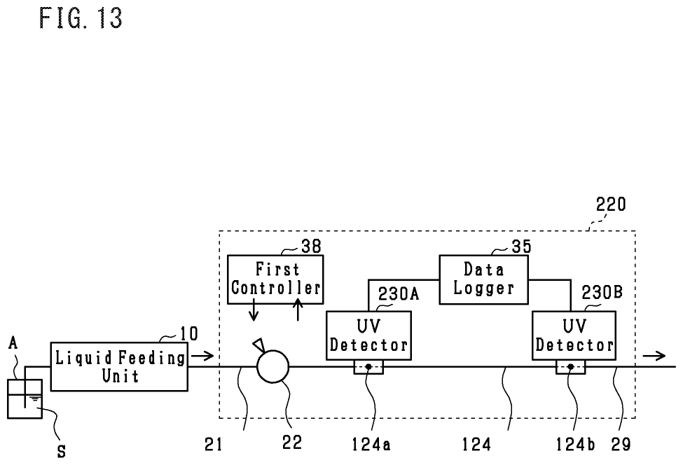

As illustrated in FIG. 13, a flow rate measurement unit 220 includes a first UV detector 230A and a second UV detector 230B instead of the aforementioned first detector 130A and the second detector 130B. An injector 22 (injection device) injects a light absorbing sample Ab into the inflow passage 21. The light absorbing sample Ab is soluble in a solvent S and exhibits a light absorption reaction in response to light having a predetermined wavelength. The light absorbing sample Ab is a solution of a light absorbing substance that absorbs light having a first wavelength. The first wavelength corresponds to ultraviolet light (UV light), for example. The light absorbing substance (predetermined substance) is, for example, uracil.

The UV detectors 230A and 230B project UV light (irradiation) with a predetermined wavelength dispersed from UV light (ultraviolet light) from a light source and detect absorbance of the UV light having the predetermined wavelength by the light absorbing sample Ab. The first UV detector 230A irradiates an inlet section 124a of a screening tube 124 with the UV light having the predetermined wavelength. The second UV detector 230B irradiates an outlet section 124b of the screening tube 124 with the UV light having the predetermined wavelength. The UV detectors 230A and 230B include, for example, light sources, diffraction gratings, flow cells, light receiving elements, data processing devices, and the like. The UV light from the light sources is dispersed into UV light having the predetermined wavelength by the diffraction gratings, is incident on the flow cells, and is then transmitted therethrough. The UV light having the predetermined wavelength that has passed through the flow cells is incident on the light receiving elements, is converted into electrical signals in proportional to light intensities, and is subjected to data processing to obtain absorbance.

A data logger 35 sequentially saves data regarding the absorbance detected by the UV detectors 230A and 230B. A first controller 38 calculates the flow rate of the solvent S based on the data read from the data logger 35 and the aforementioned predetermined volume V.

The flow rate measurement unit 220 with the aforementioned configuration calculates the flow rate of the solvent S as follows. In other words, it is possible to perform the following flow rate measurement method by using the flow rate measurement unit 220.

A liquid feeding unit 10 suctions the solvent S from a solvent container A and ejects the solvent S to the flow rate measurement unit 220 in a state where the flow rate of the solvent S to be measured is stabilized at a constant flow rate. The first controller 38 controls the injector 22, causes the injector 22 to inject the light absorbing sample Ab into the inflow passage 21, and at the same time, starts time measurement and data reading from the data logger 35. At this time, the light absorbing substance contained in the light absorbing sample Ab is dissolved in the solvent S. In other words, unlike air bubbles, the light absorbing substance does not change, as what is occasionally soluble or insoluble in the solvent S, and the light absorbing substance is always dissolved in the solvent S. Also, unlike air bubbles, the light absorbing substance is dissolved in the solvent S and is thus unlikely to adhere to an inner wall of a passage. This prevents the flow velocity of the light absorbing substance from becoming lower than the flow velocity of the solvent S. Note that the UV detectors 230A and 230B may start the detection of the absorbance before the light absorbing sample Ab is injected into the inflow passage 21 or may start the detection of the absorbance at the same time with the injection of the light absorbing sample Ab into the inflow passage 21.

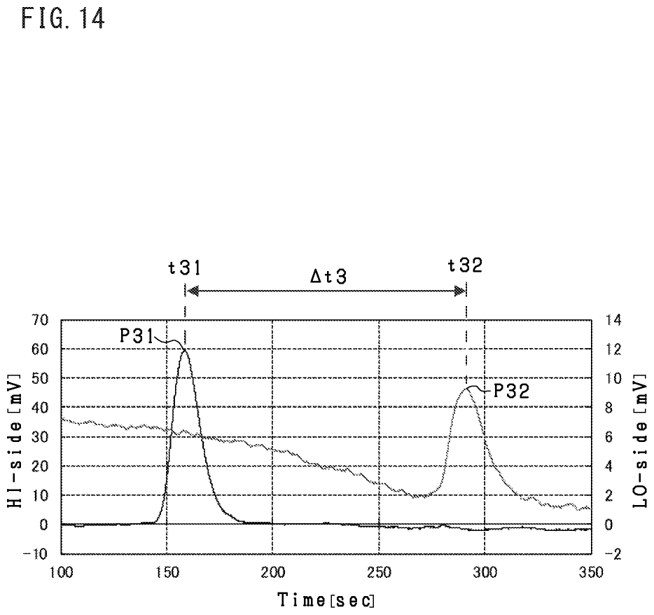

The first controller 38 creates (acquires) a waveform indicating a relationship between a time after the light absorbing sample Ab is injected by the injector 22 and detected absorbance as illustrated in FIG. 14 based on data read from the data logger 35. Based on the waveform, the first controller 38 calculates a first time t31 taken from when the light absorbing sample Ab is injected until the waveform reaches a first peak P31 and a second time t32 taken from when the light absorbing sample Ab is injected until the waveform reaches a second peak P32. The first controller 38 calculates a time difference Δt3 by subtracting the first time t31 from the second time t32. Then, the first controller 38 calculates a flow rate Q by dividing the aforementioned predetermined volume V by the time difference Δt3. It is possible to achieve effects according to the flow rate measurement unit 20 in FIG. 5 with the aforementioned configuration as well.

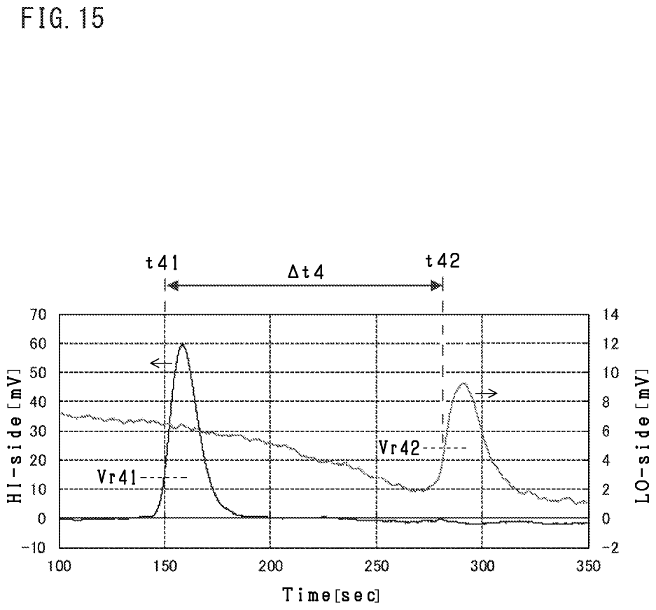

Note that the third embodiment can also be modified and performed as follows. The same parts as those in the third embodiment will be denoted by the same reference signs, and description will be omitted.
As illustrated in FIG. 15, the first controller 38 creates (acquires) a waveform indicating a relationship between a time after the light absorbing sample Ab is injected by the injector 22 and detected absorbance. Based on the waveform, the first controller 38 calculates first time t41 taken from when the light absorbing sample Ab is injected until the waveform exceeds a first threshold value Vr41 from a state where the waveform is below the first threshold value Vr41 and a second time t42 taken from when the light absorbing sample Ab is injected until, after the waveform exceeds the first threshold value Vr41, the waveform exceeds a second threshold value Vr42 from a state where the waveform is below the second threshold value Vr42. The second threshold value Vr42 is set to be smaller than the first threshold value Vr41. The first controller 38 calculates a time difference Δt4 by subtracting the first time t41 from the second time t42. Then, the first controller 38 calculates the flow rate Q by dividing the aforementioned predetermined volume V by the time difference Δt4. It is possible to suppress influences of dissolution of the light absorbing substance in the solvent S and influences of the inner wall of the passage on the light absorbing substance and to improve accuracy of measuring the flow rate of the solvent S with the aforementioned configuration as well. Note that the first threshold value Vr41 for calculating the first time t41 can also be set to the same value as the second threshold value Vr42 for calculating the second time t42.

In addition, the first to third embodiments and the modifications thereof can be modified and performed as follows. The same parts as those in the first to third embodiments and the modifications thereof will be denoted by the same reference signs, and description will be omitted.
A configuration in which a liquid is fed from a plurality of liquid feeding units to the flow rate measurement unit 20 and a flow rate sensor detects a total flow rate of the liquid fed from the liquid feeding units can also be employed.
A user may operate a syringe and refill the injector 22 with the fluorescent sample F or the light absorbing sample Ab instead of causing the syringe pump 40 to refill the injector 22 with the fluorescent sample F or the light absorbing sample Ab. Also, the control executed by the first controller 38, the second controller 18, and the controller 19 can also be executed by the user. In other words, the user may perform the aforementioned flow rate measurement method by using the flow rate measurement unit 20, or the user may perform the aforementioned flow rate measurement method by using the flow rate measurement unit 20 and the liquid feeding unit 10.
As the solvent S, it is also possible to use pure water, an organic solvent (ethanol or methanol, for example) other than acetonitrile, a mixture solution of pure water and an organic solvent, or the like.
The flow rate measurement unit 20 can also measure the flow rate in a liquid feeding unit (a liquid feeding pump or a liquid feeding device) used for applications other than the liquid chromatography. Also, the aforementioned flow rate measurement method can also be performed as a flow rate measurement method of measuring a flow rate in the liquid feeding unit (the liquid feeding pump or the liquid feeding device) used for applications other than the liquid chromatography.

Note that the first to third embodiments and the modifications thereof can be performed in combination within a range in which combinations can be made.

Although the present disclosure has been described in accordance with the embodiments, it should be understood that the present disclosure is not limited to the embodiments and the structures. The present disclosure also includes various modification examples and changes within the equivalent range. Furthermore, various combinations and modes, and further, other combinations and modes additionally including only one element, more than one element, or less than one element are also intended to fall within the scope and the range of idea of the present disclosure.

What is claimed is:

1. A flow rate measurement unit comprising:
an inflow passage into which a liquid flows;
an outflow passage out of which the liquid flows;
a screening passage comprising:
an inlet, connected to the inflow passage, into which the liquid from the inflow passage flows, and
an outlet, connected to the outflow passage, out of which the liquid flows to the outflow passage, wherein
the screening passage from the inlet to the outlet has a predetermined volume;
an injector that injects, into the inflow passage, a predetermined substance that is soluble in the liquid and exhibits a fluorescence reaction or a light absorption reaction in response to light having a predetermined wavelength;
a first detector that irradiates the inlet with the light having the predetermined wavelength, and detects a first intensity that is an intensity of the fluorescence reaction or the light absorption reaction;
a second detector that irradiates the outlet with the light having the predetermined wavelength, and detects a second intensity that is an intensity of the fluorescence reaction or the light absorption reaction; and
a first controller that calculates a flow rate of the liquid by dividing the predetermined volume by a time difference obtained by subtracting a first time from a second time, wherein
the first time is taken from when the injector injects the predetermined substance until the first intensity reaches a peak, and
the second time is taken from when the injector injects the predetermined substance until the second intensity reaches a peak.

2. The flow rate measurement unit according to claim 1, wherein
the inlet and the outlet are arranged side by side in a predetermined direction,
the first detector and the second detector constitute a single common detector, and
the common detector irradiates the inlet and the outlet with the light having the predetermined wavelength in the predetermined direction and detects the first intensity and the second intensity.

3. The flow rate measurement unit according to claim 2, wherein the screening passage is formed from a capillary tube made of glass.

4. The flow rate measurement unit according to claim 1, wherein
the first detector comprises a first detection head that emits the light having the predetermined wavelength,
the second detector comprises a second detection head that emits the light having the predetermined wavelength, and
a temperature adjustment device that adjusts, to a predetermined temperature, temperatures of the injector, a part of the inflow passage from the injector to the inlet, the first detection head, the screening passage, and the second detection head.

5. The flow rate measurement unit according to claim 1, wherein
the predetermined substance is a fluorescent substance that absorbs light having a first wavelength and exhibits the fluorescence reaction in which fluorescence having a second wavelength longer than the first wavelength is emitted,
the first detector irradiates the inlet with the light having the first wavelength as the predetermined wavelength, and detects an intensity of the fluorescence having the second wavelength as the first intensity, and
the second detector irradiates the outlet with the light having the first wavelength as the predetermined wavelength, and detects an intensity of the fluorescence having the second wavelength as the second intensity.

6. A flow rate measurement unit comprising:
an inflow passage into which a liquid flows;
an outflow passage out of which the liquid flows;
a screening passage comprising:
an inlet, connected to the inflow passage, into which the liquid from the inflow passage flows, and
an outlet, connected to the outflow passage, out of which the liquid flows to the outflow passage, wherein
the screening passage from the inlet to the outlet has a predetermined volume;
an injector that injects, into the inflow passage, a predetermined substance that is soluble in the liquid and exhibits a fluorescence reaction or a light absorption reaction in response to light having a predetermined wavelength;
a first detector that irradiates the inlet with the light having the predetermined wavelength, and detects a first intensity that is an intensity of the fluorescence reaction or the light absorption reaction;
a second detector that irradiates the outlet with the light having the predetermined wavelength, and detects a second intensity that is an intensity of the fluorescence reaction or the light absorption reaction; and
a first controller that calculates a flow rate of the liquid by dividing the predetermined volume by a time difference obtained by subtracting a first time from a second time, wherein
the first time is taken from when the injector injects the predetermined substance until the first intensity exceeds a first threshold value, and
the second time is taken from when the injector injects the predetermined substance until the second intensity exceeds a second threshold value.

7. A flow rate measurement system comprising:
the flow rate measurement unit according to claim 1; and
a liquid feeding unit comprising:
a pump that pumps the liquid,
a flow rate sensor that outputs an output signal with a correlation with a flow rate of the liquid pumped from the pump to the inflow passage; and
a second controller that controls the pump such that the output signal from the flow rate sensor becomes a target output signal.

8. The flow rate measurement system according to claim 7, wherein
the liquid feeding unit comprises a storage device that stores information,
the second controller controls the pump such that output signals from the flow rate sensor successively become a plurality of target output signals,
the first controller calculates the flow rate of the liquid in a state where the output signals from the flow rate sensor respectively become the target output signals, and
the second controller causes the storage device to store each of the target output signals and the flow rate of the liquid calculated by the first controller to be associated with each other.

9. A flow rate measurement method of measuring a flow rate of a liquid, comprising:
preparing a flow rate measurement unit comprising:
an inflow passage into which the liquid flows;
an outflow passage out of which the liquid flows;
a screening passage comprising:
an inlet, connected to the inflow passage, into which the liquid from the inflow passage flows, and
an outlet, connected to the outflow passage, out of which the liquid flows to the outflow passage, wherein
the screening passage from the inlet to the outlet has a predetermined volume;
an injector that injects, into the inflow passage, a predetermined substance that is soluble in the liquid and exhibits a fluorescence reaction or a light absorption reaction in response to light having a predetermined wavelength;
a first detector that irradiates the inlet with the light having the predetermined wavelength and detects a first intensity that is an intensity of the fluorescence reaction or the light absorption reaction; and
a second detector that irradiates the outlet with the light having the predetermined wavelength and detects a second intensity that is an intensity of the fluorescence reaction or the light absorption reaction, and
calculating a flow rate of the liquid by dividing the predetermined volume by a time difference obtained by subtracting a first time from a second time, wherein
the first time is taken from when the injector injects the predetermined substance until the first intensity reaches a peak, and
the second time is taken from when the injector injects the predetermined substance until the second intensity reaches a peak.

10. The flow rate measurement method according to claim 9, wherein
the inlet and the outlet are arranged side by side in a predetermined direction,
the first detector and the second detector constitute a single common detector, and
the common detector irradiates the inlet and the outlet with the light having the predetermined wavelength in the predetermined direction and detects the first intensity and the second intensity.

11. The flow rate measurement method according to claim 9, wherein
the flow rate measurement unit further comprises:
a pump that pumps the liquid,
a flow rate sensor that outputs an output signal with a correlation with a flow rate of the liquid pumped from the pump to the inflow passage; and
a storage device that stores information:
the method further comprising:
controlling the pump such that the output signals from the flow rate sensor successively become a plurality of target output signals;
calculating the flow rate of the liquid in a state where the output signals respectively become the target output signals; and
causing the storage device to store each of the target output signals and the flow rate of the liquid to be associated with each other.
